(19) United States
(12) Patent Application Publication
(10) Pub. No.: US 2006/0008218 A1
(43) Pub. Date: Jan. 12, 2006

(54) Method of manufacturing an optical fibre, a preform and an optical fibre

(75) Inventors: Jonathan Cave Knight, Bath (GB); Philip St. John Russell, Bath (GB); Timothy Adam Birks, Bath (GB)

Correspondence Address: FOGG AND ASSOCIATES, LLC, P.O. BOX 581339, MINNEAPOLIS, MN, 55458-1339, US

(73) Assignee: BlazePhotonics Limited, Bath (GB)

(21) Appl. No.: 10/502,251

(22) PCT Filed: Jan. 23, 2003
(86) PCT No.: PCT/GB03/00289

§ 371 Date: Aug. 3, 2005

(30) Foreign Application Priority Data
Jan. 23, 2002 (GB) 0201492.6

(51) Int. Cl. G02B 6/02

(52) U.S. Cl. 385/123

(57) ABSTRACT

A method of manufacturing an optical fibre, comprises: (i) forming a preform (10) for drawing into the fibre, the preform (10) comprising a bundle of elongate elements, (20,50) arranged to form a first region that becomes a cladding region of the fibre and a second region that becomes a core region of the fibre; (ii) drawing the preform (10) into the fibre. The bundle of elongate elements (20,50) comprises a plurality of elongate elements (20) of a lower purity dielectric material and at least one elongate element (50) of a higher purity dielectric material. The first region comprises a plurality of the lower purity elements (20) and the second region comprises the higher purity element (50).

This invention relates to the field of optical fibres.

Optical fibres are widely used in applications such as telecommunications. Such fibres are typically made entirely from solid materials such as glass, with each fibre having the same cross-sectional structure along its length. Transparent material in one part (usually the middle) of the cross-section has a higher refractive index than material in the rest of the cross-section and forms an optical core. Light is guided in the optical core by total internal reflection from the material surrounding the core, which forms a cladding region. We refer to such a fibre as a conventional fibre or a standard fibre.

Most standard fibres are made from fused silica glass, incorporating a controlled concentration of dopant, and have a circular outer boundary typically of diameter 125 microns. Standard fibres can be single-mode or multimode.

Applications often require very great lengths of optical fibre, typically tens or even hundreds of kilometres. Optical losses are therefore a very important technical consideration, as even a small loss per metre can seriously attenuate signals that are guided over such long distances in a fibre. Moreover, many applications requiring shorter lengths of fibre, such as fibre lasers, may be highly sensitive to loss.

One way of specifying the purity of glass is by its bubble class. High purity glass has a bubble class of 0 or 1. Another way is by its OH⁻ content. High purity glass typically has an OH⁻ concentration of <10 ppm.

Various techniques have been developed to produce standard optical fibre of high optical quality; such techniques are well known and include modified chemical vapour deposition (MCVD), outside vapour deposition (OVD), vapour axial deposition (VAD) and plasma-enhanced chemical vapour deposition (PECVD). Typical optical losses for fibres made by such techniques are around 0.2 dB/km at a wavelength of 1550 nm and around 3-5 dB/km at a wavelength of 850 nm.

However, production of high-purity glass by prior-art techniques is difficult, costly, and is specific to the production of a certain type of preform.

In the past few years a non-standard type of optical fibre has been demonstrated, called the photonic crystal fibre (PCF) [J. C. Knight et al., Optics Letters v. 21 p. 203]; such fibres have alternatively been called holey fibres or microstructure fibres. Typically, a PCF is made from a single solid material such as fused silica glass, within which is embedded an array of holes. Those ‘holes’ are usually air holes but may alternatively be, for example, regions of a solid material (e.g. silica doped with impurities to change its refractive index). The holes run parallel to the fibre axis and extend the full length of the fibre. A region of solid material between holes, larger than neighbouring such regions, can act as a waveguiding fibre core. Light can be guided in this core in a manner analogous to total-internal-reflection guiding in standard fibres. One way to provide such an enlarged solid region in a fibre with an otherwise periodic array of holes is to omit one or more holes from the structure. However, the array of holes need not be periodic for total-internal-reflection guiding to take place (we nevertheless refer to such a fibre as a photonic-crystal fibre).

Another mechanism for guiding light in PCFs is based on photonic bandgap effects rather than total internal reflection. For example, light can be confined inside a hollow core (an enlarged air hole) by a suitably-designed array of smaller holes surrounding the core [R. F. Cregan et al., Science v. 285 p. 1537]. True guidance in a hollow core is not possible at all in conventional fibres.

PCFs can be fabricated by stacking glass elements (rods and tubes) on a macroscopic scale to form a bundle having the required pattern and shape, and holding them in place while fusing them together. This primary preform can then be drawn into a fibre, using the same type of fibre-drawing tower that is used to draw standard fibre from a standard-fibre preform. The primary preform can, for example, be formed from fused silica elements with a diameter of about 0.8 mm.

Thus, the prior-art method of manufacturing PCFs having low loss requires a large number of high-purity rods and tubes, each having a relatively small diameter compared with preforms for standard fibres. However, prior art methods of manufacturing high-purity glass rods are not well suited to making high-purity tubes suitable for use in a PCF preform. Furthermore, most manufacturers of high-purity glass are tooled for making large boules of the glass and so making small rods requires custom manufacturing runs and is therefore expensive.

An object of the invention is to provide an improved method of manufacture that enables production of low-loss PCF at a reduced cost.

According to the invention there is provided a method of manufacturing an optical fibre, comprising: (i) forming a preform for drawing into the fibre, the preform comprising a bundle of elongate elements arranged to form a first region that becomes a cladding region of the fibre and a second region that becomes a core region of the fibre; (ii) drawing the preform into the fibre, characterised in that (a) the bundle of elongate elements comprises a plurality of elongate elements of a lower purity dielectric material and at least one elongate element of a higher purity dielectric material and (b) the first region comprises a plurality of the lower purity elements and the second region comprises the higher purity element.

Preferably, the higher purity dielectric material has a bubble class of 0 or 1. The lower purity dielectric material then has a higher bubble class, for example 2 or higher. Preferably, the dielectric material is glass. Preferably, the higher purity glass has an OH⁻ content of <1 ppm. The lower purity glass may have an OH⁻ content of >10 ppm.

Because most of the energy in a guided lowest-order mode is concentrated near to the centre of that mode, it is possible for the fibre to exhibit a low optical loss without it being necessary for all of the cladding region and all of the core region to be made out of the higher purity material; indeed, it is not even necessary for all of the core region to be made out of the higher purity material. The cost and difficulty of making low-loss fibre may thereby be reduced because the higher purity material is only used in a part of the fibre.

The core region is considered to be the part of the fibre in which light is guided rather than evanescent.

The second region may comprise a plurality of higher purity elements; thus a fibre with a larger higher purity core may be made. The first region may include at least one higher purity element. The first region may include a ring of higher purity elements that substantially surround, and are adjacent to, the second region.

The second region may include at least part of at least one of the lower purity elements, such that the core region of the drawn fibre includes lower purity material as well as higher purity material. The second region may include a plurality of the lower purity elements. The second region may include at least part of the elements forming an innermost ring of lower purity elements that substantially surround, and are adjacent to, the higher purity element(s). It may be that the only parts of the elements forming the ring that are included in the second region are the parts of the elements adjacent to the cane. The second region may include all of the ring.

Thus, although the mode may have an extensive cross-section, most of the light energy is at the mode's centre, and it is the optical quality of the glass forming the part of the fibre core in which most of the light is concentrated that is most significant in determining loss.

The elongate elements may have any suitable cross-section or any combination of cross-sections for formation of the preform; for example, the elongate elements may be canes or tubes of circular or other cross-section. The tubes may be capillaries. The tubes may be larger tubes that surround a plurality of canes or capillaries in the preform.

Preferably, the drawn fibre is a photonic crystal fibre such that the cladding region of the drawn fibre comprises a plurality of elongate bodies of a first refractive index embedded in a matrix material of a second refractive index, different from the first. Preferably, the lower purity elements comprise an outer portion that forms the matrix material and an inner portion that forms the elongate body, in the cladding region of the drawn fibre. For example, the lower purity elements may be dielectric tubes, such that the inner portion is a hole.

In PCFs, the light will often be guided in a star-shaped lowest-order mode that spreads into the part of the fibre in which holes are found (The holes in the fibre result from the holes in the tubes of the preform).

Preferably, the higher purity element(s) is/are a cane or canes.

Also according to the invention there is provided a preform for drawing into an optical fibre, the preform comprising a bundle of elongate elements arranged to form a first region that becomes a cladding region of the fibre and a second region that becomes a core region of the fibre, characterised in that (a) the bundle of elongate elements comprises a plurality of elongate elements of a lower purity dielectric material and at least one elongate element of a higher purity dielectric material and (b) the first region comprises a plurality of the lower purity elements and the second region comprises the higher purity element.

Also according to the invention there is provided an optical fibre, the fibre comprising a cladding region and a core region, characterised in that the cladding region comprises dielectric material of a lower purity and the core region comprises dielectric material of a higher purity.

Preferably, the cladding region comprises a plurality of elongate bodies of a first refractive index, embedded in a matrix material of a second refractive index. Preferably, the elongate bodies are elongate holes. The core region may include material of a lower purity. The cladding region may include material of a higher purity.

An embodiment of the invention will now be described, by way of example only, with reference to the drawings, of which:

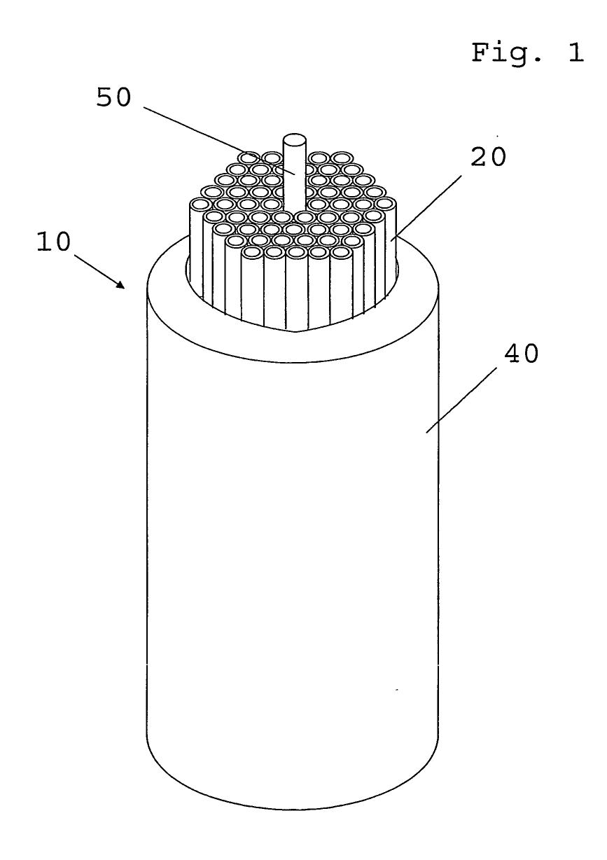

FIG. 1 is a perspective view of preform, according to the invention, formed of a bundle of tubes and canes;

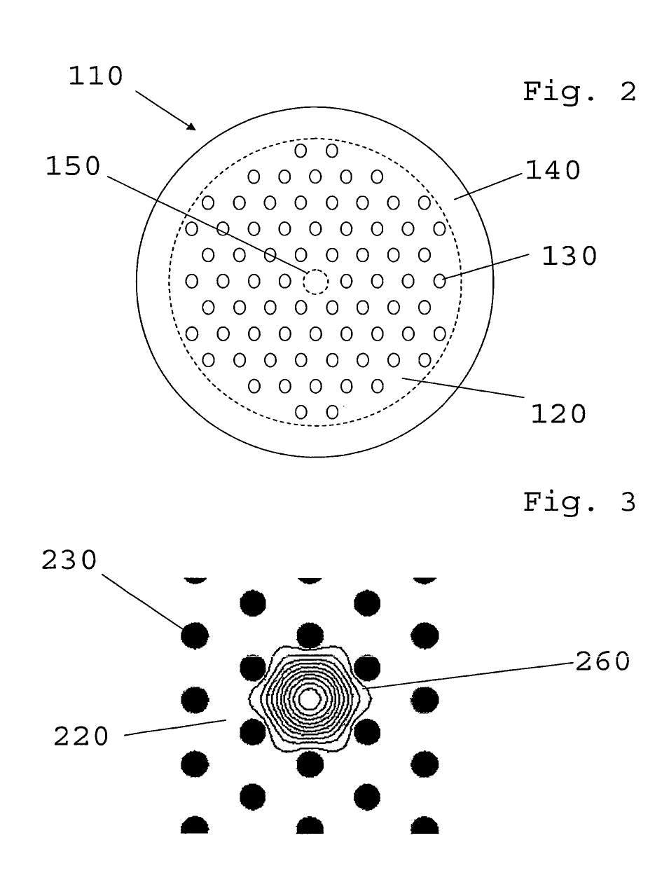

FIG. 2 is a cross-sectional view of a fibre drawn from the preform of FIG. 1;

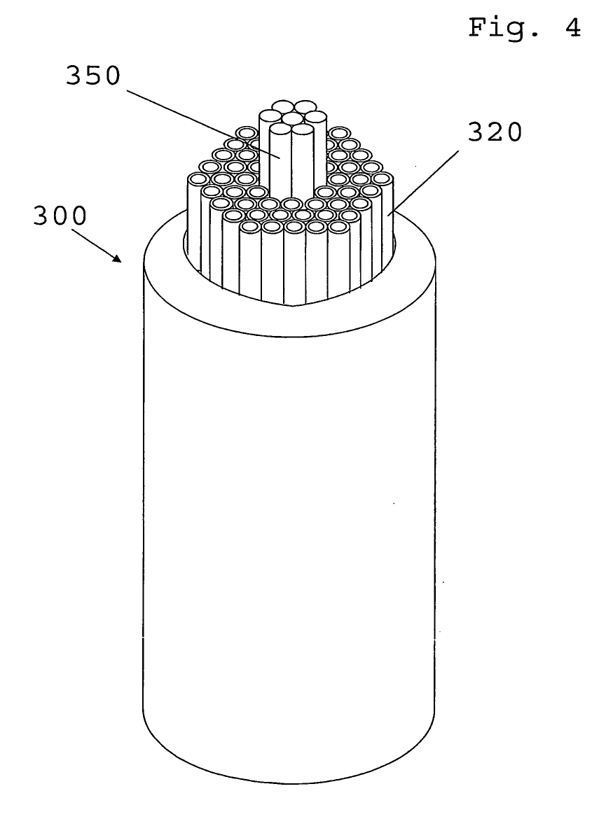

FIG. 3 is an image of the intensity of light in a guided mode in a microstructured fibre.

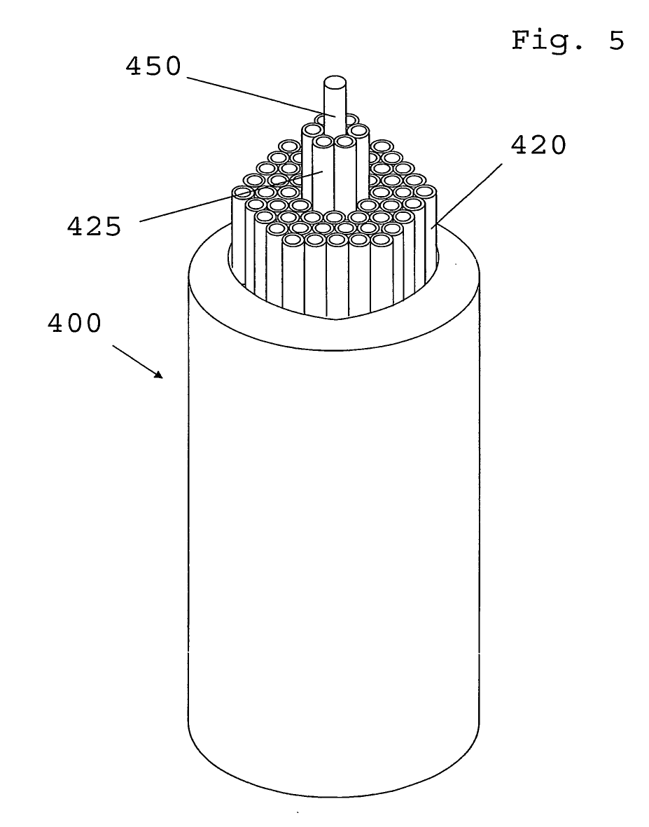

FIG. 4 is a perspective view of another preform according to the invention.

FIG. 5 is a perspective view of another preform according to the invention.

The preform of FIG. 1 comprises a bundle 10 of elongate silica tubes 20 that are arranged in a triangular lattice pattern in the cross-section of the bundle. The bundle is held together by a silica jacket 40. The silica forming the tubes is HOQ310 from Heraeus QuartzTech Ltd., 1 Craven Court, Canada Road, Byfleet, Surrey, KT14 7JL, which has a bubble class of 2 to 3 and 30 ppm OH⁻. At the centre of the bundle is an elongate cane 50 of solid silica. The silica forming the cane is glass manufactured by the VAD process, which has a bubble class of 0 and <3 ppm OH⁻.

The bundle 10 is drawn on a fibre drawing tower into fibre 110 (FIG. 2) in the same way as standard fibres are typically drawn from their preforms. In fibre 110, tubes 20 have fused to form an array of holes 130 and silica matrix regions 120 (in which holes 130 are embedded). At the centre of the fibre 110, the translational symmetry of the triangular lattice pattern of the holes 130 is broken. At the site of the defect that breaks the symmetry is region 150 (marked by a dotted line), which is formed of the high-purity glass of cane 50. The outer parts of fibre 140 are a silica jacket region 140 that does not contain any holes and is derived from jacket 40. Silica regions 120, 140, 150 have all fused to form a whole broken only by holes 130 and interstitial holes (not shown in FIG. 2) that result from imperfect tiling of the tubes 20 and cane 50 (which are of circular cross-section).

Light is guided in fibre 110 by a form of total internal reflection. Holes 130 reduce the effective refractive index of the parts of the fibre in which they are present. (The effective refractive index of those parts will be between the refractive index of the air in hole 130 and the refractive index of silica regions 120; the exact value of the effective refractive index depends upon the distribution of light in the fibre and can readily be calculated by methods known to those skilled in the art.) As solid silica region 150 has a higher refractive index than the effective refractive index of regions containing holes 130, regions containing holes 130 act as a cladding region that confines light by total internal reflection to a core region in and around solid region 150. It should be noted that the holes 130 are arranged on a triangle lattice as a result of their method of manufacture. There is no requirement for strict periodicity of holes in an index-guiding PCF.

The core region of fibre 140 is regarded as those parts of the fibre in which light is guided rather than evanescent. Light mode 260 in FIG. 3 is typical of the guided mode of a fibre having the hole structure of the fibre of FIG. 2. Mode 260 substantially fills the solid silica region between innermost holes 230 and also spreads between those holes, forming a six-pointed star-like shape. The intensity of mode 260 is at its highest in the centre and most of the light energy is within the region corresponding to higher-purity region 150 of the fibre of FIG. 2. However, the area of mode 260 also spreads considerably into regions 220, corresponding to lower purity regions 120.

Because most of the light energy guided in the fibre of FIG. 2 is in the high-purity region 150, the loss seen by that light is low. The effect of spread into the lower purity regions 220 is not significant because relatively little light energy is guided in those regions, even though a significant fraction of the cross-sectional area of the guided mode spreads into those lower-purity regions. Thus a low-loss PCF 110 is provided by the use of only one high purity element, cane 50. The cost and difficulty of making fibre 110 is thus considerably less than the cost of making a similar fibre entirely from the higher-purity glass of which cane 50 is comprised.

In an alternative embodiment (FIG. 4) preform 300 is similar to that of FIG. 1 but the core region is drawn from a group of seven high-purity canes 350, six of which replace the innermost ring of tubes 20. Tubes 320 surround the seven canes and form a cladding region. Such an arrangement is useful for providing a PCF with a large core region for supporting several modes.

In a further alternative embodiment (FIG. 5), preform 400 is similar to that of FIG. 1, but an innermost ring of tubes 425 is also made of the higher purity glass (in addition to cane 450). Tubes 420, which surround tubes 425, are of the lower purity glass and form a higher-purity part of the cladding region in the drawn fibre. Such an arrangement ensures that a greater fraction of the guided mode propagates through higher-purity material.

1. A method of manufacturing an optical fibre, comprising:
(i) forming a preform for drawing into the fibre, the preform comprising a bundle of elongate elements arranged to form a first region that becomes a cladding region of the fibre and a second region that becomes a core region of the fibre;
(ii) drawing the preform into the fibre, characterised in that (a) the bundle of elongate elements comprises a plurality of elongate elements of a lower purity dielectric material and at least one elongate element of a higher purity dielectric material and (b) the first region comprises a plurality of the lower purity elements and the second region comprises the higher purity element.

2. A method as claimed in claim 1, in which the second region comprises a plurality of higher purity elements.

3. A method as claimed in claim 1, in which the first region includes at least one higher purity element.

4. A method as claimed in claim 3, in which the first region includes a ring of higher purity elements that substantially surround, and are adjacent to, the second region.

5. A method as claimed in claim 1, in which the second region includes at least part of at least one of the lower purity elements, such that the core region of the drawn fibre includes lower purity material as well as higher purity material.

6. A method as claimed in claim 5, in which the second region includes at least part of the elements forming an innermost ring of lower purity elements that substantially surround, and are adjacent to, the higher purity element (s).

7. A method as claimed in claim 6, in which the only parts of the elements forming the ring that are included in the second region are the parts of the elements adjacent to the cane.

8. A method as claimed in claim 1, in which the drawn fibre is a photonic crystal fibre such that the cladding region of the drawn fibre comprises a plurality of elongate bodies of a first refractive index embedded in a matrix material of a second refractive index, different from the first.

9. A method as claimed in claim 8, in which the lower purity elements comprise an outer portion that forms the matrix material and an inner portion that forms the elongate body, in the cladding region of the drawn fibre.

10. A method as claimed in claim 9, in which the lower purity elements are dielectric tubes, such that the inner portion is a hole.

11. A method as claimed in claim 1, in which the higher purity element (s) is/are a cane or canes.

12. A preform for drawing into an optical fibre, the preform comprising a bundle of elongate elements arranged to form a first region that becomes a cladding region of the fibre and a second region that becomes a core region of the fibre, characterised in that
(a) the bundle of elongate elements comprises a plurality of elongate elements of a lower purity dielectric material and at least one elongate element of a higher purity dielectric material and
(b) the first region comprises a plurality of the lower purity elements and the second region comprises the higher purity element.

13. An optical fibre, the fibre comprising a cladding region and a core region, characterised in that the cladding region comprises dielectric material of a lower purity and the core region comprises dielectric material of a higher purity.

14. A fibre as claimed in claim 13, in which the cladding region comprises a plurality of elongate bodies of a first refractive index, embedded in a matrix material of a second refractive index.

15. A fibre as claimed in claim 14, in which the elongate bodies are elongate holes.

16. A fibre as claimed in claim 13, in which the core region includes material of a lower purity.

17. A fibre as claimed in claim 13, in which the cladding region includes material of a higher purity.

18. (canceled)

19. (canceled)
